(19) United States
(12) Patent Application Publication
(10) Pub. No.: US 2013/0136045 A1
(43) Pub. Date: May 30, 2013

(54) METHODS AND DEVICES FOR FACILITATING OPTIMIZED GENERAL PAGE MESSAGE MONITORING

(71) Applicant: Qualcomm Incorporated, San Diego, CA (US)

(72) Inventors: Bhaskara V. Batchu, Hyderabad (IN); Venkata Siva Prasad Gude, Hyderabad (IN); Anand Rajurkar, Hyderabad (IN)

(73) Assignee: Qualcomm Incorporated, San Diego, CA (US)

(21) Appl. No.: 13/651,448

(22) Filed: Oct. 14, 2012

Related U.S. Application Data
(60) Provisional application No. 61/564,223, filed on Nov. 28, 2011.

(51) Int. Cl. H04W 52/02

(52) U.S. Cl. 370/311

(57) ABSTRACT

Access terminals are adapted to receive a non-empty general page message (GPM) which includes a number of page records that is less than a predefined maximum number of page records. In response to receiving the non-empty general page message (GPM), the access terminal can enter into a sleep state of a slotted idle mode. A method operational on an access terminal includes receiving a general page message (GPM) with at least one page record. A number of page records included in the general page message (GPM) may be determined to be less than a maximum number of page records allowed in the general page message (GPM). The access terminal may enter a sleep state in response to determining the number of page records in the received general page message (GPM) is less than the maximum allowed number of page records. Other aspects, embodiments, and features are also included.

### CROSS REFERENCE TO RELATED APPLICATION & PRIORITY CLAIM

The present application for patent claims priority to Provisional Application No. 61/564,223 entitled “METHODS AND DEVICES FOR FACILITATING IMPROVED STAND-BY TIME WITH OPTIMIZED GENERAL PAGE MESSAGE MONITORING” filed Nov. 28, 2011, and assigned to the assignee hereof and hereby expressly incorporated by reference herein as if fully set forth below and for all applicable purposes.

### TECHNICAL FIELD

Embodiments of the present invention relate generally to wireless communication, and more specifically, to methods and devices for enabling and facilitating power conservation in access terminals when operating in an idle mode.

### BACKGROUND

Wireless communications systems are widely deployed to provide various types of communication content such as voice, video, packet data, messaging, broadcast, and so on. These systems may be accessed by various types of access terminals adapted to facilitate wireless communications, where multiple access terminals share the available system resources (e.g., time, frequency, and power). Examples of such wireless communications systems include code-division multiple access (CDMA) systems, time-division multiple access (TDMA) systems, frequency-division multiple access (FDMA) systems and orthogonal frequency-division multiple access (OFDMA) systems.

Access terminals adapted to access one or more wireless communications systems are becoming increasingly popular, with consumers often using power-intensive applications that run on increasingly complicated and power consuming access terminals. Access terminals are typically powered by a limited power source (e.g., rechargeable battery) and, consequently, may operate in various modes to assist in extending the operating life of the access terminal between charges. Features which may assist in extending the operating life of the access terminal between recharging are therefore beneficial.

### BRIEF SUMMARY OF SOME EXAMPLES

Various features and aspects of the present disclosure are adapted to facilitate power conservation when monitoring general page messages (GPMs) received in slotted idle mode. According to at least one aspect of the present disclosure, access terminals are provided, which are adapted to efficiently return to a sleep state during slotted idle mode operations. According to one or more examples, such access terminals may include a communications interface and a storage medium coupled with a processing circuit. The processing circuit may be adapted to receive a non-empty general page message (GPM) via the communications interface. The non-empty general page message (GPM) may include a number of page records, where the number of included page records is less than a predefined maximum number of page records. The processing circuit may further enter a sleep state of an idle mode in response to receiving the non-empty general page message (GPM).

Further aspects provide methods operational on an access terminals and/or access terminals including means to perform such methods. One or more examples of such methods may include receiving a general page message (GPM) comprising at least one page record. A determination may be made whether a number of page records included in the general page message (GPM) is less than a maximum number of page records allowed in the general page message (GPM). When the number of page records is less than the maximum allowed number of page records, the access terminal can enter a sleep state of the idle mode.

Still further aspects include computer-readable mediums comprising programming operational on an access terminal. According to one or more examples, such programming may be adapted for receiving a non-empty general page message (GPM), where the non-empty general page message (GPM) includes a number of page records less than a predefined maximum number of page records. The programming may further be adapted for entering a sleep state of an idle mode in response to receiving the non-empty general page message (GPM).

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a network environment in which one or more aspects of the present disclosure may find application.

FIG. 2 is a block diagram illustrating an example of a protocol stack architecture which may be implemented by an access terminal according to some embodiments of the present invention.

FIG. 3 is a block diagram illustrating a sequence of at least some operations performed by an access terminal during an awake state of a slotted idle mode according to at least one example.

FIG. 4 is a block diagram illustrating at least one example of a sequence of at least some operations performed by an access terminal during an awake state of a slotted idle mode according to one or more features of the present disclosure.

FIG. 5 is a block diagram illustrating select components of an access terminal according to at least one example.

FIG. 6 is a flow diagram illustrating operations of the access terminal according to at least one example.

FIG. 7 is a flow diagram illustrating an example of a method operational on an access terminal according to at least one example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of wireless communication systems, network architectures, and communication standards. Certain aspects of the disclosure are described below for CDMA and 3rd Generation Partnership Project 2 (3GPP2) 1x protocols and systems, and related terminology may be found in much of the following description. However, those of ordinary skill in the art will recognize that one or more aspects of the present disclosure may be employed and included in one or more other wireless communication protocols and systems.

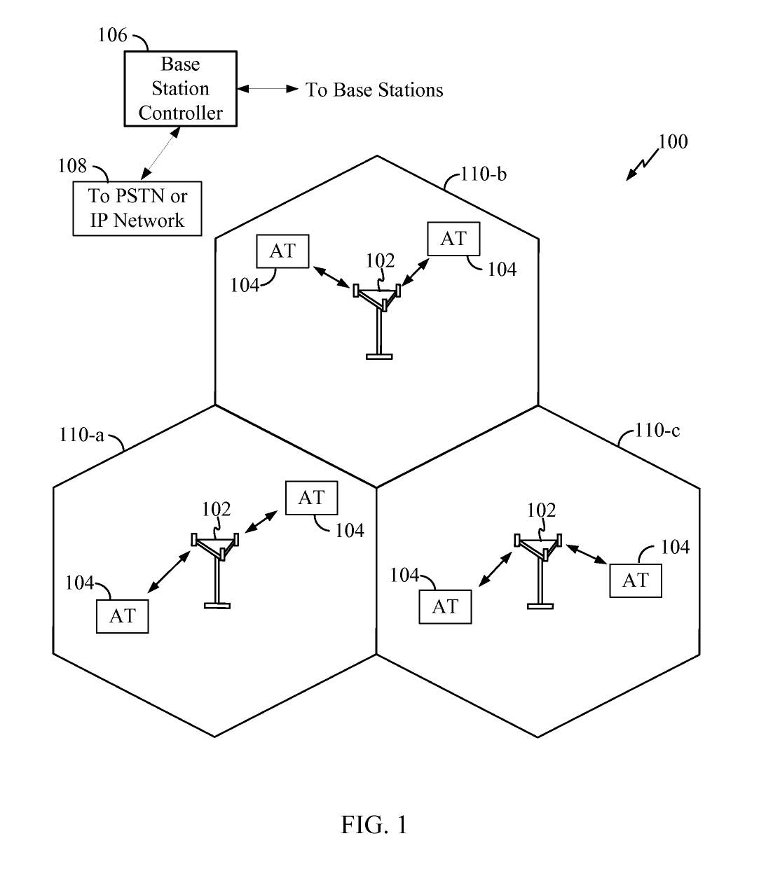

FIG. 1 is a block diagram illustrating an example of a network environment in which one or more aspects of the present disclosure may find application. The wireless communication system 100 generally includes one or more base stations 102, one or more access terminals 104, one or more base station controllers (BSC) 106, and a core network 108 providing access to a public switched telephone network (PSTN) (e.g., via a mobile switching center/visitor location register (MSC/VLR)) and/or to an IP network (e.g., via a packet data switching node (PDSN)). The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a Single Carrier Frequency Division Multiple Access (SC-FDMA) signal, etc. Each modulated signal may be sent on a different carrier and may carry control information (e.g., pilot signals), overhead information, data, etc.

The base stations 102 can wirelessly communicate with the access terminals 104 via a base station antenna. The base stations 102 may each be implemented generally as a device adapted to facilitate wireless connectivity (for one or more access terminals 104) to the wireless communications system 100. A base station 102 may also be referred to by those skilled in the art as an access point, a base transceiver station (BTS), a radio base station, a radio transceiver, a transceiver function, a basic service set (BSS), an extended service set (ESS), a Node B, a femto cell, a pico cell, and/or some other suitable terminology.

The base stations 102 are configured to communicate with the access terminals 104 under the control of the base station controller 106 via multiple carriers. Each of the base stations 102 can provide communication coverage for a respective geographic area. The coverage area 110 for each base station 102 here is identified as cells 110-a, 110-b, or 110-c. The coverage area 110 for a base station 102 may be divided into sectors (not shown, but making up only a portion of the coverage area). In a coverage area 110 that is divided into sectors, the multiple sectors within a coverage area 110 can be formed by groups of antennas with each antenna responsible for communication with one or more access terminals 104 in a portion of the cell.

One or more access terminals 104 may be dispersed throughout the coverage areas 110, and may wirelessly communicate with one or more sectors associated with each respective base station 102. An access terminal 104 may generally include one or more devices that communicate with one or more other devices through wireless signals. Such access terminals 104 may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. The access terminals 104 may include mobile terminals and/or at least substantially fixed terminals. Examples of access terminals 104 include mobile phones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, and/or other communication/computing devices which communicate, at least partially, through a wireless or cellular network.

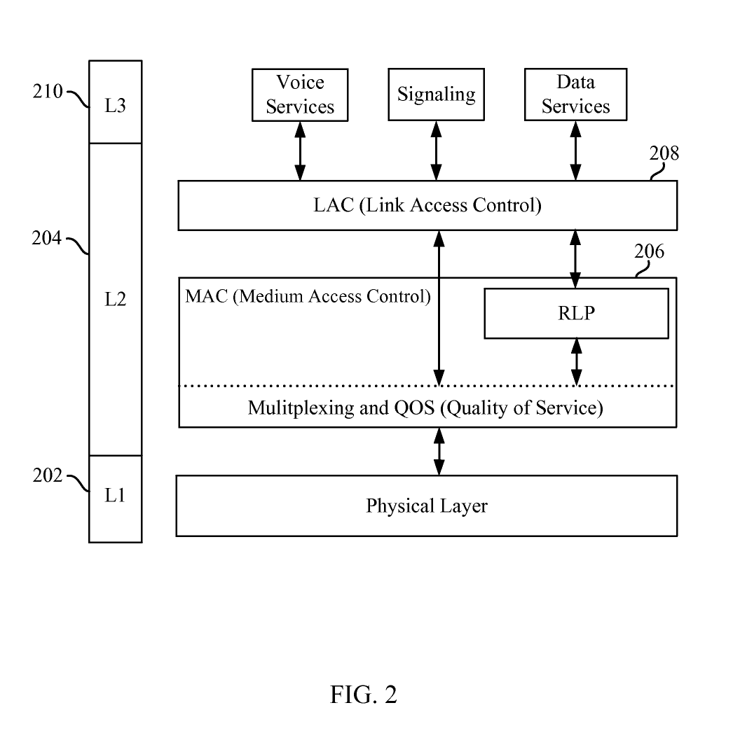

The access terminal 104 may be adapted to employ a protocol stack architecture for communicating data between the access terminal 104 and one or more network nodes of the wireless communication system 100 (e.g., the base station 102). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 2 is a block diagram illustrating an example of a protocol stack architecture which may be implemented by an access terminal 104. Referring to FIGS. 1 and 2, the protocol stack architecture for the access terminal 104 is shown to generally include three layers: Layer 1 (L1), Layer 2 (L2), and Layer 3 (L3).

Layer 1 202 is the lowest layer and implements various physical layer signal processing functions. Layer 1 202 is also referred to herein as the physical layer 202. This physical layer 202 provides for the transmission and reception of radio signals between the access terminal 104 and a base station 102.

The data link layer, called layer 2 (or “the L2 layer”) 204 is above the physical layer 202 and is responsible for delivery of signaling messages generated by Layer 3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of higher layers' protocol data units using the services provided by the physical layer 202. The MAC sublayer 206 may manage the access of data from the higher layers to the shared air interface.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and the access terminal 104. The L3 layer 210 makes use of the services provided by the L2 layer. Information (both data and voice) message are also passed through the L3 layer 210.

As an access terminal 104 operates within the system 100, the access terminal 104 may employ various modes of operation, including a dedicated mode and an idle mode. In dedicated mode, the access terminal 104 may actively exchange data (e.g., voice or data calls or sessions) with one or more base stations (e.g., base stations 102 in FIG. 1). In idle mode, the access terminal 104 may monitor control channels, such as a paging channel (PCH) for paging messages. Such paging messages may include messages that alert the access terminal 104 to the occurrence of an incoming voice or data call and control/overhead messages that carry system information and other information for the access terminal 104.

When operating in the idle mode, paging messages may be sent on the paging channel to the access terminal 104 at designated time intervals. Instead of monitoring the paging channel continuously, the access terminal 104 can conserve power by periodically monitoring the paging channel in a slotted idle mode, which may also be referred to by those of skill in the art as discontinuous reception mode or DRX mode. In the slotted idle mode, the access terminal 104 wakes up from a “sleep” state at known time intervals, enters an “awake” state and processes the paging channel for messages. If additional communication is not required, the access terminal 104 can revert back to the sleep state until the next designated time.

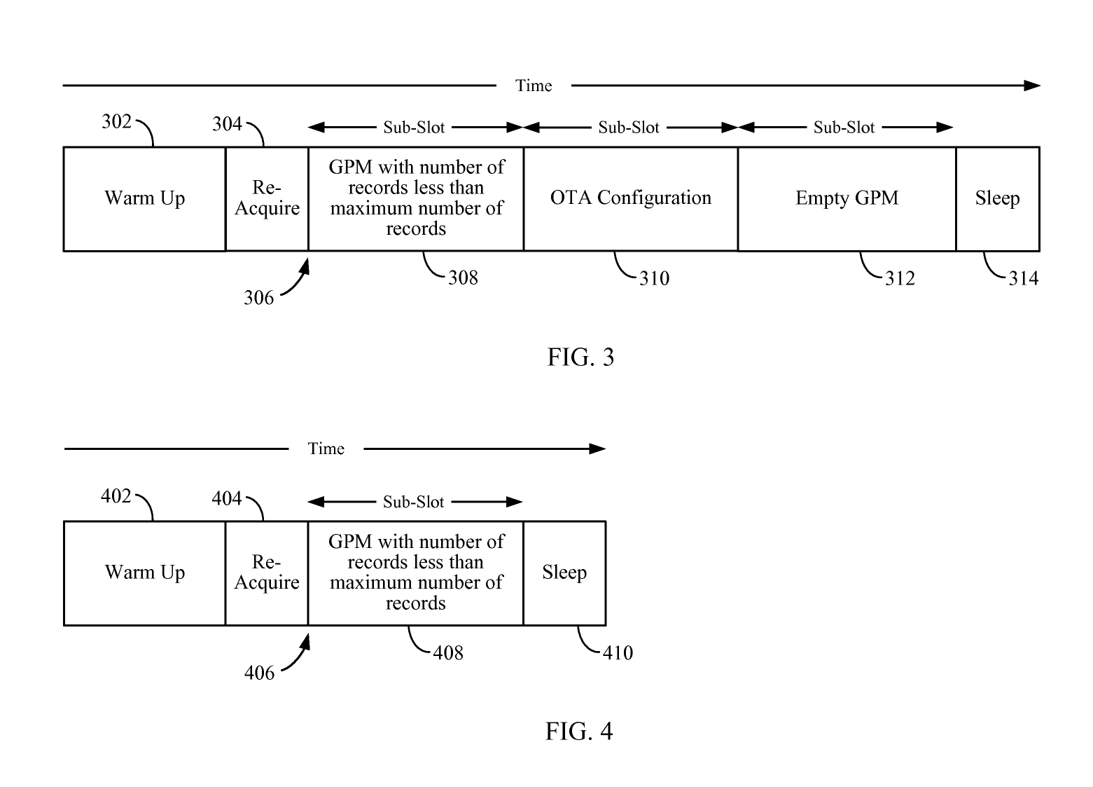

Typically, the access terminal 104 is adapted to revert back to the sleep state in response to receipt of an empty general page message (GPM) on the paging channel. For example, as illustrated in the block diagram shown in FIG. 3, a slot having a specified duration (e.g., about 80 milliseconds) can be subdivided into a plurality of sub-slots. In the example illustrated, each of the sub-slots may have a duration of about 20 milliseconds. Initially, an access terminal 104 enters the awake state of the slotted idle mode by warming up 302 and re-acquiring the network at 304. For example, the access terminal 104 can power ON one or more circuits and/or components of its receiver chain and re-acquire 304 the paging channel. At the start of the slot (e.g., at the slot boundary indicated by arrow 306), the access terminal 104 may receive a non-empty general page message (GPM) 308 during the first sub-slot. This non-empty general page message (GPM) may include page records (or page messages) for one or more different access terminals 104. If the non-empty general page message (GPM) does not include a page record intended for the access terminal 104, then the access terminal 104 continues to monitor the paging channel.

Following one or more non-empty general page messages (GPMs), the access terminal 104 may receive further messages during at least some of the remaining sub-slots. For example, as shown the access terminal 104 may receive an over-the-air (OTA) configuration message 310 during the next sub-slot. Following the OTA configuration message 310, the access terminal 104 may receive an empty general page message (GPM) 312 in the subsequent sub-slot. This empty general page message (GPM) 312 may include a message with no pages records for any access terminals 104. The empty general page message (GPM) 312 may serve as an indicator that there are no more page records to be sent by the base station during the current awake cycle, so that the access terminal 104 can immediately revert back to the sleep state without further monitoring for general page messages (GPMs). In response to this empty general page message (GPM) 312, the access terminal 104 is typically configured to revert back to the sleep state 314 of the slotted idle mode by powering down one or more circuits and/or components (e.g., one or more circuits and/or components of the receiver chain).

Although there were no page records intended for an access terminal 104 in the non-empty general page message (GPM) 308 of the illustrated example, the conventional access terminal will continue to monitor the paging channel until the empty general page message (GPM) 312 is received. After receiving the empty general page message (GPM) 312, the access terminal can revert back to the sleep state. It may take a significant amount of time for an access terminal to receive an empty general page message (GPM) following the non-empty general page message (GPM). For example, even if the empty general page message (GPM) 312 were sent in the sub-slot immediately following the non-empty general page message (GPM) 308 (e.g., in the sub-slot showing the OTA configuration message 310), the access terminal would still take at least the amount of the time of the sub-slot (e.g., 20 milliseconds in this example) to enter the sleep state.

According to an aspect of the present disclosure, access terminals can be adapted to revert to the sleep state before receiving an empty general page message (GPM). For instance, access terminals of the present disclosure may be adapted to determine from a non-empty general page message (GPM) that there are no future page records intended for the access terminal during a particular awake cycle, and can revert back to the sleep state based on this determination. FIG. 4 is a block diagram illustrating at least one example of a sequence of at least some operations performed by an access terminal of the present disclosure during an awake state of a slotted idle mode. Similar to the example described above with reference to FIG. 3, the access terminal may initially enter the awake state of the slotted idle mode by warming up 402 and re-acquiring the network at 404. For example, the access terminal can power ON 402 one or more circuits and/or components of its receiver chain and re-acquire 404 the paging channel.

At the start of the slot (e.g., at the slot boundary indicated by arrow 406), the access terminal may receive a non-empty general page message (GPM) 408 during the first sub-slot. This non-empty general page message (GPM) may include page records (or page messages), but none of the page records may be intended for the access terminal. According to an aspect of the present disclosure, if the non-empty general page message (GPM) does not include a page record intended for the access terminal and has fewer than the maximum allowed number of page records, then the access terminal can revert back to the sleep state 410 without waiting for an empty general page message (GPM). As can be seen by comparison of the FIGS. 3 and 4, an access terminal employing the features described with reference to FIG. 4 can power down and return to the sleep state at least one sub-slot (e.g., about 20 milliseconds in the described examples) earlier than it can when employing the sequence of FIG. 3.

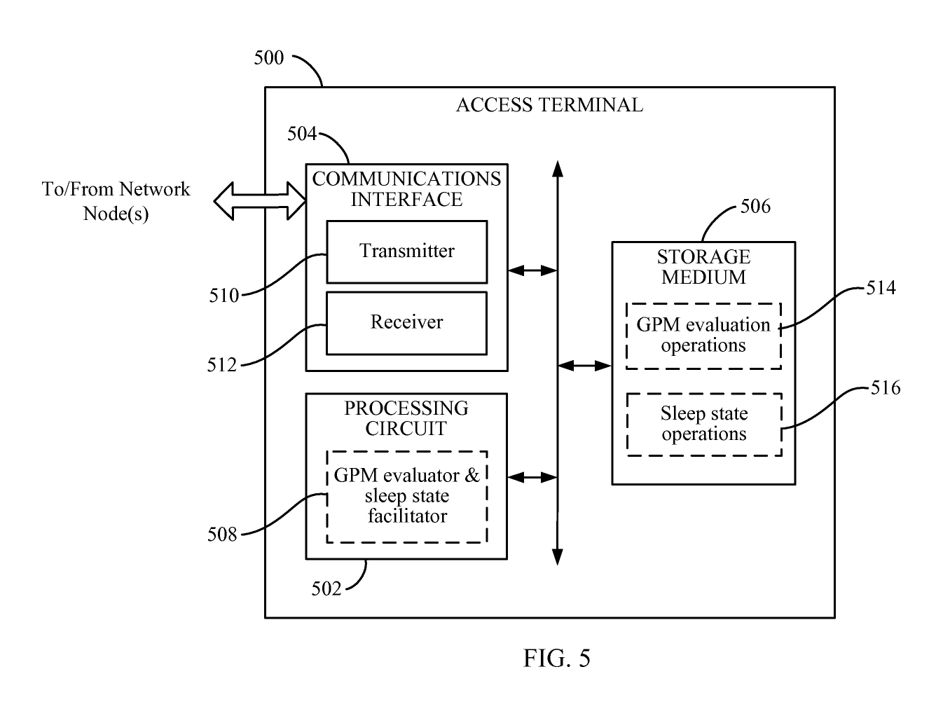

FIG. 5 is a block diagram illustrating select components of an access terminal 500 adapted to employ such features according to at least one example. The access terminal 500 may include a processing circuit 502 coupled to or placed in electrical communication with a communications interface 504 and a storage medium 506.

The processing circuit 502 is arranged to obtain, process and/or send data, control data access and storage, issue commands, and control other desired operations. The processing circuit 502 may include circuitry configured to implement desired programming provided by appropriate media in at least one example. For example, the processing circuit 502 may be implemented as one or more processors, one or more controllers, and/or other structure configured to execute executable programming Examples of the processing circuit 502 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 502 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 502 are for illustration and other suitable configurations within the scope of the present disclosure are also contemplated.

The processing circuit 502 is adapted for processing, including the execution of programming, which may be stored on the storage medium 506. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 502 may include a general page message (GPM) evaluator and sleep state facilitator 508. The general page message (GPM) evaluator and sleep state facilitator 508 may include circuitry and/or programming (e.g., programming stored on the storage medium 506) adapted to perform evaluation of general page messages (GPMs) (e.g., to determine a number of page records in a general page message (GPM) and to compare that determined number to a maximum allowed number of page records) and/or to facilitate sleep state operation of the access terminal 500.

The communications interface 504 is configured to facilitate wireless communications of the access terminal 500. For example, the communications interface 504 may include circuitry and/or programming adapted to facilitate the communication of information bi-directionally with respect to one or more network nodes. The communications interface 504 may be coupled to one or more antennas (not shown), and includes wireless transceiver circuitry, including at least one transmitter 510 (e.g., one or more transmitter chains) and/or at least one receiver 512 (e.g., one or more receiver chains).

The storage medium 506 may represent one or more computer-readable, machine-readable, and/or processor-readable devices for storing programming, such as processor executable code or instructions (e.g., software, firmware), electronic data, databases, or other digital information. The storage medium 506 may also be used for storing data that is manipulated by the processing circuit 502 when executing programming. The storage medium 506 may be any available media that can be accessed by a general purpose or special purpose processor, including portable or fixed storage devices, optical storage devices, and various other mediums capable of storing, containing or carrying programming. By way of example and not limitation, the storage medium 506 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 506 may be coupled to the processing circuit 502 such that the processing circuit 502 can read information from, and write information to, the storage medium 506. That is, the storage medium 506 can be coupled to the processing circuit 502 so that the storage medium 506 is at least accessible by the processing circuit 502, including examples where the storage medium 506 is integral to the processing circuit 502 and/or examples where the storage medium 506 is separate from the processing circuit 502 (e.g., resident in the access terminal 500, external to the access terminal 500, distributed across multiple entities).

Programming stored by the storage medium 506, when executed by the processing circuit 502, causes the processing circuit 502 to perform one or more of the various functions and/or process steps described herein. For example, the storage medium 506 may include general page message (GPM) evaluation operations (or instructions) 514 and/or sleep state operations (or instructions) 516. The general page message (GPM) evaluation operations 514 and the sleep state operations 516 can be implemented by the processing circuit 502 in, for example, the general page message (GPM) evaluator and sleep state facilitator 508 to perform evaluation of general page messages (GPMs) (e.g., to determine a number of page records in a general page message (GPM) and to compare that determined number to a maximum allowed number of page records) and/or to facilitate sleep state operation of the access terminal 500. Thus, according to one or more aspects of the present disclosure, the processing circuit 502 may be adapted to perform (in conjunction with the storage medium 506) any or all of the processes, functions, steps and/or routines for any or all of the access terminals described herein (e.g., access terminal 104 or 500). As used herein, the term “adapted” in relation to the processing circuit 502 may refer to the processing circuit 502 being one or more of configured, employed, implemented, or programmed to perform a particular process, function, step and/or routine according to various features described herein. In at least some examples, the various programming (e.g., programming associated with the general page message (GPM) evaluator and sleep state facilitator 508, the general page message (GPM) evaluation operations 514 and/or the sleep state operations 516) can be implemented at the L3 layer 210 and/or the physical layer 202 of the protocol stack described above with reference to FIG. 2.

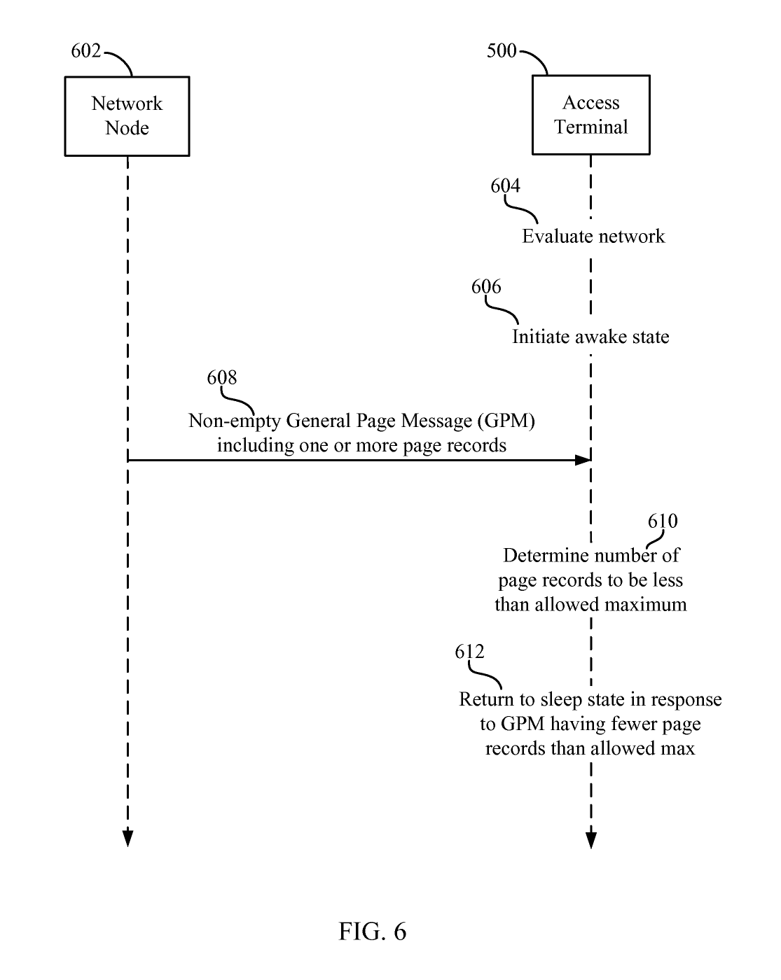

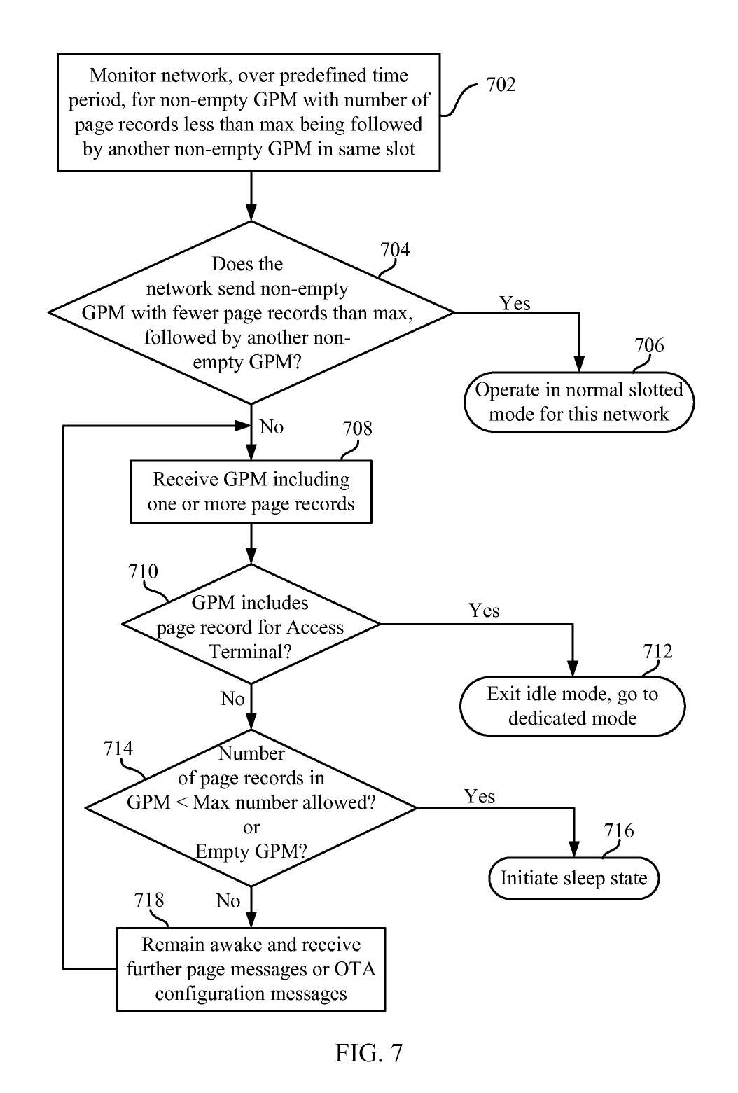

In operation, the access terminal 500 is adapted to evaluate a non-empty general page message (GPM), and initiate the idle sleep state when the access terminal 500 determines that there will likely not be a page record for the access terminal 500 during a current paging channel slot. FIG. 6 is a flow diagram illustrating operations of the access terminal according to at least one example. As shown, the access terminal 500 may wirelessly communicate with one or more network nodes 602. The access terminal 500 may operate in a slotted idle mode, where the access terminal 500 switches between a sleep state and an awake state, as discussed above.

Initially, the access terminal 500 may evaluate the network over a predefined period of time 604. If, based on this network evaluation, it is determined that the network is configured to transmit a non-empty general page message (GPM) including a number of page records less than the predefined maximum number of page records, followed by a subsequent non-empty general page message (GPM) in the same slot (e.g., during a single awake cycle), then the access terminal 500 may perform standard slotted idle mode operations, where the access terminal 500 returns to the sleep state in response to receiving an empty general page message (GPM). On the other hand, if it is determined that the network is not so configured, then the access terminal 500 may continue through the following steps.

Before the arrival of its assigned slot, the access terminal 500 wakes up from the idle sleep state and initiates the awake state 606 by preparing the access terminal 500 to monitor the paging channel. For instance, the access terminal 500 may power on the communications interface, or a portion thereof (e.g., the receiver 512) and reacquire the paging channel. During the assigned slot, the network node 602 may transmit a non-empty general page message (GPM) 608. The non-empty general page message (GPM) includes one or more page records intended for various respective access terminals.

The access terminal 500 can evaluate the non-empty general page message (GPM), and may determine 610 that the non-empty general page message (GPM) includes a number of page records that is less than the maximum number allowed in the non-empty general page message (GPM). In other words, the access terminal 500 can determine that the non-empty general page message (GPM) includes fewer page records than the maximum number allowed in a general page message (GPM).

If the number of page records in the non-empty general page message (GPM) is less than the allowed maximum number, then the access terminal 500 can determine that there will not be any more non-empty general page messages (GPMs) during the current slot. This determination is based on the idea that if there were more page records to be sent during the current slot, then the network node 602 would have included those page records in the non-empty general page message (GPM) until it was full. If the non-empty general page message (GPM) was full (i.e., included the max allowed number of page records), then there would be a chance of a subsequent non-empty general page message (GPM) during the current slot. However, since the non-empty general page message (GPM) is not full, the access terminal 500 determines that there will not be any further non-empty general page messages (GPMs) during the current slot.

In response to the determination that the non-empty general page message (GPM) does not include a number of page records equal to the maximum number of allowed page records, the access terminal 500 returns to the idle sleep state 612 and waits for the occurrence of the next assigned slot.

According to another aspect of the present disclosure, methods operational on an access terminal are provided for facilitating initiation of an idle mode sleep state in response to a non-empty general page message (GPM) that includes fewer page records than the maximum allowed number of page records. FIG. 7 is a flow diagram illustrating an example of such a method according to at least one example. Referring to FIGS. 5 and 7, an access terminal 500 may initially determine whether a network from which general page messages (GPMs) are being received (e.g., a network on which the access terminal 500 is camped) is configured to transmit a non-empty general page message (GPM) having a number of page records less than a predefined maximum number of page records followed by a subsequent non-empty general page message (GPM) during a single slot.

For example, at step 702, the processing circuit 502 (e.g., the GPM evaluator & sleep state facilitator 508) may monitor one or more slots on the paging channel via the communications interface 504 for a predefined period of time to determine whether the network is configured to transmit a non-empty general page message (GPM) having a number of page records less than the maximum number allowed, and a subsequent non-empty general page message (GPM) in the same slot. From information obtained during the monitoring at step 702, the access terminal 500 can decide whether the network is adapted to send a non-empty general page message (GPM) with fewer page records than the maximum allowed, followed by another non-empty GPM in the same slot cycle at step 704. For instance, the processing circuit 502 (e.g., the GPM evaluator & sleep state facilitator 508) executing the GPM evaluation operations 514 may make a determination based on general page messages (GPMs) evaluated during the network monitoring period.

If, at step 704, it is determined that the network does send a first non-empty general page message (GPM) with fewer page records than the maximum allowed, followed by a second non-empty general page message (GPM) during the same awake cycle, then the access terminal 500 may operate in a normal (or conventional) slotted mode for the particular network, at step 706. For example, in response to this determination, the processing circuit 502 may enable the access terminal 500 to continue in an awake state of the idle mode and receive one or more subsequent general page messages (GPMs) in response to receiving a non-empty general page message (GPM) having number of page records less than the predefined maximum number of page records.

If it is determined at step 704 that the network does not send a first non-empty general page message (GPM) with fewer page records than the maximum allowed, followed by a second non-empty general page message (GPM), then the access terminal 500 can operate according to one or more of the features described herein. For example, the processing circuit 502 may enable the access terminal 500 to enter the sleep state following a non-empty general page message (GPM) including a number of page records less than the predefined maximum number of page records. With the access terminal 500 enabled in this manner, the access terminal 500 may operate in a idle mode while connected to the network.

At step 708, the access terminal 500 may receive a general page message (GPM) including at least one page record. For example, the processing circuit 502 may cause the communications interface 504 to power up and synchronize to the paging channel prior to the beginning of an assigned slot. When the assigned slot begins, the processing circuit 502 can receive a general page message (GPM) via the communications interface 504.

At step 710, the access terminal 500 determines whether the received general page message (GPM) includes a page record intended for the access terminal 500. For example, the processing circuit 502 can determine whether the received general page message (GPM) includes a page record intended for the access terminal 500. In at least one implementation, the GPM evaluation operations 514 may cause the processing circuit 502 (e.g., the GPM evaluator & sleep state facilitator 508) to execute this determination. If there is a page record included for the access terminal 500, then the processing circuit 502 may exit the idle mode and enter dedicated mode to facilitate further communications with the network, at step 712.

If the received general page message (GPM) does not include a page record intended for the access terminal 500, then the access terminal 500 determines whether the number of page records included in the received general page message (GPM) is less than a predefined maximum number of page records allowed in the general page message (GPM) or whether the received general page message (GPM) is empty, at step 714. For example, the processing circuit 502 (e.g., the GPM evaluator & sleep state facilitator 508) executing the GPM evaluation operations 514 may make the determination at step 714. In at least one example, the processing circuit 502 may determine from the received general page message (GPM) the number of page records included therein. The processing circuit 502 may then compare the determined number of page records to a number representing the predefined maximum number of page records. In at least one instance, the processing circuit 502 (e.g., the GPM evaluator & sleep state facilitator 508) implementing the GPM evaluation operations 514 may calculate the predefined maximum number of allowed page records based on a maximum payload allowed in a paging channel message. In other instances, the predefined maximum number of allowed page records may be obtained from a previously received value adapted to represent the predefined maximum number of page records, which previously received value may be stored in the storage medium 504 of the access terminal 500.

If the access terminal 500 determines at step 714 that the received general page message (GPM) is an empty general page message (GPM), the access terminal 500 may enter the sleep state of the slotted idle mode. If the access terminal 500 determines at step 714 that the received general page message (GPM) is a non-empty general page message including a number of page records less than the predefined maximum number of page records, then the access terminal 500 can initiate the sleep state at step 716. For example, when the processing circuit 502 (e.g., the GPM evaluator & sleep state facilitator 508) executing the GPM evaluation operations 514 and/or the sleep state operations 516 determines that the number of page records included in the received general page message (GPM) is less than the predefined maximum number of page records, then the processing circuit 502 may return to a sleep state of the slotted idle mode. For instance, the processing circuit 502 may power OFF one or more circuit and/or one or more components of the communications interface 504, as well as any other operation(s) consistent with entering a sleep state of the slotted idle mode.

If the access terminal 500 determines at step 714 that the number of page records included in the general page message (GPM) is equal to the predefined maximum allowed number of page records, then the access terminal 500 can remain awake to receive one or more subsequent general page messages (GPMs) and/or one ormore over-the-air (OTA) configuration messages, at step 718. For example, the processing circuit (e.g., the GPM evaluator & sleep state facilitator 508) may remain in the awake state of the slotted idle mode in order to receive one or more subsequent messages, such as a subsequent general page message (GPM) and/or an over-the-air configuration message when the received general page message (GPM) includes the predefined maximum number of page records.

The forgoing features may facilitate access terminals and methods operational on access terminals that can conserve power and increase the operating life of an access terminal between battery charges. In addition to the power savings attainable by one or more features of the present disclosure, one or more features may also reduce the quantity of time an access terminal is “online” (e.g. actively communicating with the network) when operating in a slotted idle mode. This reduction in the amount of time in which an access terminal operates in the awake state of the slotted idle mode may also be beneficial in Dual SIM Dual Standby (DSDS) access terminals by reducing the number of conflicts between multiple subscriptions. The reduction of conflicts between multiple subscriptions can improve the performance of Dual SIM Dual Standby (DSDS) access terminals. The foregoing benefits are just a couple of non-limiting examples, and additional and/or different benefits may also be obtained from one or more of the features set forth in the present disclosure.

While the above discussed aspects, arrangements, and embodiments are discussed with specific details and particularity, one or more of the components, steps, features and/or functions illustrated in FIGS. 1, 2, 3, 4, 5, 6 and/or 7 may be rearranged and/or combined into a single component, step, feature or function or embodied in several components, steps, or functions. Additional elements, components, steps, and/or functions may also be added or not utilized without departing from the invention. The apparatus, devices and/or components illustrated in FIGS. 1 and/or 5 may be configured to perform or employ one or more of the methods, features, parameters, or steps described in FIGS. 2, 3, 4, 6 and/or 7. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

We claim:

1. An access terminal, comprising:
a communications interface;
a storage medium; and
a processing circuit coupled to the communications interface and the storage medium, the processing circuit adapted to:
receive via the communications interface a non-empty general page message (GPM) comprising a number of page records less than a predefined maximum number of page records; and
enter a sleep state of an idle mode in response to receiving the non-empty general page message (GPM).

2. The access terminal of claim 1, wherein the processing circuit is further adapted to:
determine whether a network from which the non-empty general page message (GPM) is received is configured to:
transmit during a slot a non-empty general page message (GPM) including a number of page records fewer than the predefined maximum number of page records; and
transmit a subsequent non-empty general page message (GPM) during the slot including one or more page records.

3. The access terminal of claim 2, wherein the processing circuit is adapted to:
enable the access terminal to enter the sleep state following a non-empty general page message (GPM) comprising a number of page records less than the predefined maximum number of page records when the determination detects that the network is not configured to transmit a non-empty general page message (GPM) including a number of page records fewer than the predefined maximum number of page records followed by a subsequent non-empty general page message (GPM) during a single slot.

4. The access terminal of claim 2, wherein the processing circuit is adapted to:
enable the access terminal to continue in an awake state of the idle mode and receive one or more subsequent general page messages (GPMs) in response to a non-empty general page message (GPM) comprising a number of page records less than the predefined maximum number of page records when the determination detects that the network is configured to transmit a non-empty general page message (GPM) including a number of page records fewer than the predefined maximum number of page records followed by a subsequent non-empty general page message (GPM) during a single slot.

5. The access terminal of claim 1, wherein the processing circuit is further adapted to:
evaluate the received non-empty general page message (GPM) to determine whether the non-empty general page message (GPM) comprises a number of page records less than the predefined maximum number of page records.

6. The access terminal of claim 5, wherein the processing circuit adapted to evaluate the received non-empty general page message (GPM) comprises the processing circuit adapted to:
determine a number of page records included in the received non-empty general page message (GPM); and
compare the determined number of page records to a predefined number representing the maximum number of page records.

7. The access terminal of claim 1, wherein the processing circuit is adapted to:
calculate the predefined maximum number of page records based on a maximum payload for a message transmitted on a paging channel.

8. A method operational on an access terminal, comprising:
receiving a general page message (GPM) comprising at least one page record;
determining whether a number of page records included in the general page message (GPM) is less than a maximum number of page records allowed in the general page message (GPM); and
entering a sleep state of an idle mode in response to determining the number of page records is less than the maximum allowed number of page records.

9. The method of claim 8, further comprising:
determining whether a network from which the general page message (GPM) is received is configured to transmit during a slot a non-empty general page message (GPM) including a number of page records fewer than the predefined maximum number of page records, and transmit a subsequent non-empty general page message (GPM) during the slot including one or more page records.

10. The method of claim 9, further comprising:
enabling the access terminal to enter the sleep state following a non-empty general page message (GPM) comprising a number of page records less than the predefined maximum number of page records when the determination concludes that the network is not configured to transmit a non-empty general page message (GPM) including a number of page records fewer than the predefined maximum number of page records followed by a subsequent non-empty general page message (GPM) during a single slot.

11. The method of claim 9, further comprising:
enabling the access terminal to continue in an awake state of the idle mode and receive one or more subsequent general page messages (GPMs) in response to a non-empty general page message (GPM) comprising a number of page records less than the predefined maximum number of page records when the determination concludes that the network is configured to transmit a non-empty general page message (GPM) including a number of page records fewer than the predefined maximum number of page records followed by a subsequent non-empty general page message (GPM) during a single slot.

12. The method of claim 8, further comprising:
continuing in an awake state of the idle mode in response to determining the number of page records is equal to the maximum allowed number of page records.

13. The method of claim 8, wherein determining whether the number of page records included in the general page message (GPM) is less than a maximum number of page records allowed in the general page message (GPM) comprises:
determining a number of page records included in the received general page message (GPM); and
comparing the determined number of page records to a predefined maximum number of page records.

14. An access terminal, comprising:
means for receiving a general page message (GPM) comprising at least one page record;
means for determining that a number of page records included in the general page message (GPM) is less than a maximum number of page records allowed in the general page message (GPM); and
means for entering a sleep state of an idle mode in response to determining the number of page records is less than the maximum allowed number of page records.

15. The access terminal of claim 14, further comprising:
means for determining whether a network from which the general page message (GPM) is received is configured to transmit during a slot a non-empty general page message (GPM) including a number of page records fewer than the predefined maximum number of page records, and transmit a subsequent non-empty general page message (GPM) during the slot including one or more page records.

16. The access terminal of claim 15, further comprising:
means for enabling the access terminal to enter the sleep state following a non-empty general page message (GPM) comprising a number of page records less than the predefined maximum number of page records when the determination concludes that the network is not configured to transmit a non-empty general page message (GPM) including a number of page records fewer than the predefined maximum number of page records followed by a subsequent non-empty general page message (GPM) during a single slot.

17. The access terminal of claim 15, further comprising:
means for enabling the access terminal to continue in an awake state of the idle mode and receive one or more subsequent general page messages (GPMs) in response to a non-empty general page message (GPM) comprising a number of page records less than the predefined maximum number of page records when the determination concludes that the network is configured to transmit a non-empty general page message (GPM) including a number of page records fewer than the predefined maximum number of page records followed by a subsequent non-empty general page message (GPM) during a single slot.

18. The access terminal of claim 14, further comprising:
means for continuing in an awake state of the idle mode in response to determining the number of page records is equal to the maximum allowed number of page records.

19. A computer-readable medium, comprising programming operational on an access terminal for:
receiving a non-empty general page message (GPM) comprising a number of page records less than a predefined maximum number of page records; and
entering a sleep state of an idle mode in response to receiving the non-empty general page message (GPM).

20. The computer-readable medium of claim 19, further comprising programming for:
determining whether a network from which the non-empty general page message (GPM) is transmitted is configured to:
transmit during a slot a non-empty general page message (GPM) including a number of page records fewer than the predefined maximum number of page records; and
transmit a subsequent non-empty general page message (GPM) during the slot including one or more page records.

21. The computer-readable medium of claim 20, further comprising programming for:
enabling the access terminal to enter the sleep state following a non-empty general page message (GPM) comprising a number of page records less than the predefined maximum number of page records when the determination detects that the network is not configured to transmit a non-empty general page message (GPM) including a number of page records fewer than the predefined maximum number of page records followed by a subsequent non-empty general page message (GPM) during a single slot.

22. The computer-readable medium of claim 19, further comprising programming for:
evaluating the received non-empty general page message (GPM) to determine whether the non-empty general page message (GPM) comprises a number of page records less than the predefined maximum number of page records.

23. The computer-readable medium of claim 22, wherein evaluating the received non-empty general page message (GPM) to determine whether the non-empty general page message (GPM) comprises a number of page records less than the predefined maximum number of page records comprises:
determining a number of page records included in the received non-empty general page message (GPM); and
comparing the determined number of page records to a predefined number representing the maximum number of page records.

24. The computer-readable medium of claim 23, wherein the predefined number representing the maximum number of page records is pre-provisioned on the access terminal.

25. The computer-readable medium of claim 23, wherein the predefined number representing the maximum number of page records is calculated based on a maximum payload for a message transmitted on a paging channel.
